(19) United States
(12) Patent Application Publication
(10) Pub. No.: US 2025/0173729 A1
(43) Pub. Date: May 29, 2025

(54) METHOD AND APPARATUS FOR PROTECTING NON-FUNGIBLE TOKEN DIGITAL ASSETS

(71) Applicant: SAMSUNG ELECTRONICS CO., LTD., Suwon-si (KR)

(72) Inventors: Peng ZHANG, Nanjing (CN); Delong WANG, Nanjing (CN); Yu ZHU, Nanjing (CN); Xiao CHEN, Nanjing (CN)

(73) Assignee: SAMSUNG ELECTRONICS CO., LTD., Suwon-si (KR)

(21) Appl. No.: 19/040,532

(22) Filed: Jan. 29, 2025

Related U.S. Application Data
(63) Continuation of application No. PCT/KR2023/009062, filed on Jun. 28, 2023.

(30) Foreign Application Priority Data
Aug. 31, 2022 (CN) 202211053836.9

(51) Int. Cl. G06Q 20/40; G06Q 20/06; G06Q 20/36

(52) U.S. Cl. CPC G06Q 20/407; G06Q 20/06; G06Q 20/36

(57) ABSTRACT

A method and apparatus for protecting non-fungible token (NFT) digital assets, implemented by a terminal device of a user, including: creating, using a third-party application account associated with the user, a private blockchain account for the user; adding NFT information included in a blockchain account associated with the user into an e-wallet corresponding to the third-party application account, wherein the blockchain account is different from the private blockchain account; based on a target NFT being selected by the user in the e-wallet after the user logs into the third-party application account, initiating an off-chain transaction between the blockchain account and the private blockchain account in order to freeze a digital asset corresponding to the target NFT; and canceling the off-chain transaction corresponding to the frozen digital asset in order to unfreeze the frozen digital asset based on the frozen digital asset satisfying a predetermined NFT protection cancellation condition.

### CROSS-REFERENCE TO RELATED APPLICATIONS

This application is continuation of International Application PCT/KR2023/009062 filed on Jun. 28, 2023, in the Korean Intellectual Property Receiving Office, which is based on and claims priority to Chinese Patent Application No. 202211053836.9 filed on Aug. 31, 2022, in the China National Intellectual Property Administration, the disclosures of which are incorporated by reference herein in their entireties.

### BACKGROUND

### 1. Field

The disclosure relates to blockchain technology, and more particularly, to a method and apparatus for protecting non-fungible token (NFT) digital assets.

### 2. Description of Related Art

A non-fungible token (NFT) may be a data unit on a blockchain digital ledger. Each token may represent a piece of unique digital data which may serve as an electronic certification or certificate of ownership of a virtual commodity. Due to its non-interchangeability, the NFT may represent a digital asset, such as at least one of a painting, an artwork, a sound, a video, an item in a game, and a creative work in another form. The NFT may be a unique encrypted currency token representing the digital asset, and may be traded. Although a work corresponding to the digital asset may be replicated indefinitely, tokens representing the work may be tracked using the underlying blockchains, and therefore may provide a proof of ownership to a buyer. The NFT may have a unique contract address, and may be used to confirm that the collection is unique and indivisible when the contract address is confirmed.

Some approaches to NFT application schemes may have potential security risks For example, an NFT digital asset may be bound to particular account from a blockchain service, such as an Ethereum account. A blockchain account, however, may be protected only by a private key, which may mean that only a private key is required to be inputted when a user logs into a blockchain account, and the blockchain account may be accessed by any user that is able to provide the private key. Accordingly, if a private key of a user is obtained by another person, digital assets in the blockchain account may be stolen, for example by being sold or transferred to another person.

### SUMMARY

Provided is a method and apparatus for protecting NFT digital assets, and to enhance the security of NFT digital assets.

In accordance with an aspect of the disclosure, a method for protecting non-fungible token (NFT) digital assets, implemented by a terminal device of a user includes: creating, using a third-party application account associated with the user, a private blockchain account for the user; adding NFT information included in a blockchain account associated with the user into an e-wallet corresponding to the third-party application account, wherein the blockchain account is different from the private blockchain account; based on a target NFT being selected by the user in the e-wallet after the user logs into the third-party application account, initiating an off-chain transaction between the blockchain account and the private blockchain account in order to freeze a digital asset corresponding to the target NFT; and canceling the off-chain transaction corresponding to the frozen digital asset in order to unfreeze the frozen digital asset based on the frozen digital asset satisfying a predetermined NFT protection cancellation condition.

The creating the private blockchain account may include: based on an NFT security service instruction being received from the user after the user logs in the third-party application account: triggering, by a blockchain client included in the terminal device, a blockchain server to create the private blockchain account for the user based on device information corresponding to the terminal device and account information corresponding to the third-party application account, receiving metadata corresponding to the private blockchain account from the blockchain server, and storing the metadata in the terminal device.

The adding the NFT information into the e-wallet may include: adding the blockchain account into the e-wallet based on a blockchain account addition instruction received from the user after the user logs into the third-party application account; receiving parameter information received from the user for acquiring the NFT information; based on the received parameter information including a private key associated with the blockchain account, acquiring, by a blockchain client included in the terminal device, other NFT information included in the blockchain account from a blockchain server using an identifier of the blockchain account and the private key, acquiring other NFT metadata corresponding to the NFT information from an NFT provider using the acquired other NFT information, and storing the other NFT metadata into the e-wallet; and based on the received parameter information including an identifier of the target NFT in the blockchain account, acquiring NFT metadata corresponding to the target NFT from the NFT provider using the identifier of the target NFT, determining whether the user is an owner of the target NFT based on the NFT metadata, and storing the NFT metadata into the e-wallet based on the user being the owner of the target NFT.

The selecting the target NFT may include: after the user logs in the third-party application account, acquiring NFT metadata corresponding to an NFT and displaying the NFT metadata in a content display interface of the e-wallet; and based on receiving an NFT protection confirmation instruction from the user, selecting the NFT as the target NFT.

The initiating the off-chain transaction may include: receiving a private key from the user based on the target NFT being selected by the user, wherein the private key is associated with the blockchain account; triggering, by a blockchain client included in the terminal device, a blockchain server to perform a verification of the blockchain account and the private blockchain account using account information corresponding to the blockchain account and account information corresponding to the private blockchain account, wherein the account information corresponding to the blockchain account may include an account identifier and the private key; generating an off-chain transaction channel corresponding to the off-chain transaction, and transmitting the off-chain transaction channel to an account server after the verification succeeds; and based on the off-chain transaction channel, the account server may trigger the blockchain server to freeze the digital asset corresponding to the off-chain transaction using the off-chain transaction channel.

The canceling the off-chain transaction may include: based on determining that the frozen digital asset of the target NFT satisfies the predetermined NFT protection cancellation condition, receiving a private key associated with the blockchain account from the user after the user logs into the third-party application account; triggering, by a blockchain client in the terminal device, a blockchain server to perform a verification of the blockchain account and the private blockchain account based on account information corresponding to the blockchain account and account information corresponding to the private blockchain account, wherein the account information corresponding to the blockchain account may include an account identifier and the private key; and closing an off-chain transaction channel corresponding to the frozen digital asset after the verification succeeds, and triggering the blockchain server to unfreeze the digital asset corresponding to the off-chain transaction channel based on the closing of the off-chain transaction channel.

The predetermined NFT protection cancellation condition may be satisfied based on at least one of: a predetermined protection effective period of the frozen digital asset expiring, and an NFT protection cancellation instruction of the user being received.

The method may further include updating an off-chain transaction channel corresponding to the off-chain transaction based on the blockchain account.

In accordance with an aspect of the disclosure, an apparatus for protecting non-fungible token (NFT) digital assets, includes: at least one processor; and a memory storing instruction which, when executed by the at least one processor, cause the apparatus to: create a private blockchain account for a user using a third-party application account associated with the user, and add NFT information included in a blockchain account associated with the user into an e-wallet corresponding to the third-party application account, wherein the blockchain account is different from the private blockchain account; based on a target NFT being selected by the user in the e-wallet after the user logs into the third-party application account, initiate an off-chain transaction between the blockchain account and the private blockchain account in order to freeze a digital asset corresponding to the target NFT; and cancel the off-chain transaction based on the frozen digital asset satisfying a predetermined NFT protection cancellation condition after the user logs into the third-party application account, in order to unfreeze the frozen digital asset.

In accordance with an aspect of the disclosure, a non-transitory computer-readable storage medium, storing computer-readable instructions which, when executed by at least one processor of a device for protecting non-fungible token (NFT) digital assets, cause the device to: create, using a third-party application account associated with a user, a private blockchain account for the user; add NFT information included in a blockchain account associated with the user into an e-wallet corresponding to the third-party application account, wherein the blockchain account is different from the private blockchain account; based on a target NFT being selected by the user in the e-wallet after the user logs into the third-party application account, initiate an off-chain transaction between the blockchain account and the private blockchain account in order to freeze a digital asset corresponding to the target NFT; and cancel the off-chain transaction corresponding to the frozen digital asset in order to unfreeze the frozen digital asset based on the frozen digital asset satisfying a predetermined NFT protection cancellation condition.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart of a process for protecting non-fungible token (NFT) digital assets according to an embodiment of the present disclosure;

FIG. 2 is a schematic diagram illustrating a process for adding an NFT into a user e-wallet of a third-party application account according to an embodiment of the present disclosure;

FIGS. 3A and 3B are a schematic diagrams illustrating an effect of adding an NFT into a user e-wallet of a third-party application account according to an embodiment of the present disclosure;

FIG. 4 is a schematic diagram of a process for protecting an NFT digital asset according to an embodiment of the present disclosure;

FIG. 5 is a schematic diagram illustrating an example of canceling protection of an NFT digital asset according to an embodiment of the present disclosure;

FIG. 6 is a schematic diagram illustrating application of an off-chain transaction according to an embodiment of the present disclosure; and

FIG. 7 is a schematic diagram illustrating the structure of an apparatus according to an embodiment of the present disclosure.

FIG. 8 is a schematic diagram illustrating the structure of an electronic device for protecting NFT digital assets according to an embodiment of the present disclosure.

### DETAILED DESCRIPTION

To make the objectives, technical solutions and merits of the present disclosure more apparent, embodiments of the present disclosure are hereinafter described in detail with reference to the accompanying drawings.

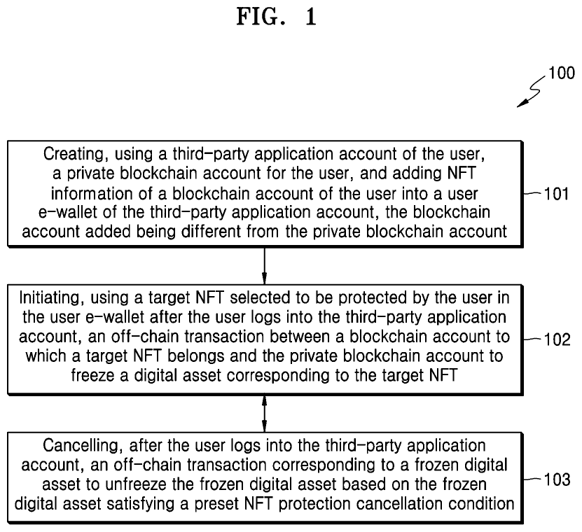

FIG. 1 is a flowchart illustrating a method according to an embodiment of the present disclosure. As shown in FIG. 1, a process 100 for protecting NFT digital assets may be implemented by a terminal device of a user.

At operation 101, a private blockchain account may be created for a user using a third-party application account associated with the user; NFT information included in a blockchain account associated with the user may added into a user e-wallet (e.g., a digital wallet or electronic wallet) associated with the third-party application account. The blockchain account added may be different from the private blockchain account.

Operation 101 may also include creating a private blockchain account for a user when the user has successfully logged into a third-party application account. Operation 101 may also include adding the NFT information of another blockchain account of the user into a user e-wallet associated with the third-party application account, so that the user may subsequently select the NFT of a to-be-protected digital asset from the user e-wallet to freeze the corresponding digital asset using an off-chain transaction between the private blockchain account and the blockchain account to which the selected NFT belongs. In this way, an effect similar to locking the digital assets into a safe for protection can be achieved, the digital assets may avoid being illegally transferred due to the loss of the private key for accessing the blockchain account.

In addition, by adding the NFT information into a user e-wallet associated with a third-party application account and creating a private blockchain account when the user has successfully logs into the third-party application account, the security of the above blockchain operations may be improved by taking advantage of various security authentication schemes provided by the third-party application platform for account login. For example, these security authentication schemes may include at least one of login authentication based on hardware-related information (e.g., device identifiers and serial numbers) and account-related information (e.g., account numbers and global unique identifiers), and additional security verifications such as verification through emails, verification through text messages (e.g., short system (SMS) messages), or the like.

An example of creating a private blockchain account for a user using a third-party application account of the user is described below.

Based on an NFT security service instruction of the user being received after the user logs into the third-party application account, a blockchain client in a terminal device may trigger a blockchain server to create a private blockchain account associated with the user using device information corresponding to the terminal device and account information corresponding to the third-party application account, and store metadata corresponding to the private blockchain account received from the blockchain server into the terminal device.

In the example of creating a private blockchain account for a user described above, after a user logs into a third-party application account and passes the server side account authentication, the user may activate an NFT protection service function to issue an NFT security service instruction. Based on the instruction being received, the blockchain client in the terminal device may trigger a blockchain server to create a private blockchain account for the user using device information corresponding to the terminal device and account information corresponding to the third-party application account. After the private blockchain account is successfully created, the terminal device may receive metadata corresponding to the private blockchain account from the blockchain server and store the metadata in the terminal device. The private blockchain account may be associated with the third-party application account the user is currently logged into, and when different users log into the terminal device, different private blockchain accounts may be created if the users agree.

In the example described above, after a user successfully logs into a third-party application account, a private blockchain account (which may be, for example, equivalent to a private wallet) may be created for the user using device information corresponding to a terminal device and information about the third-party application account, in order to associate the private blockchain account with the third-party application account. The private blockchain account may be allowed to be used only in off-chain transactions. Private and public keys used by the private blockchain account may only exist in the terminal device. The private blockchain account may be allowed to be used only after being activated by the user action of logging into the associated third-party application account.

The third-party application in the embodiment may refer to an application other than a blockchain application client installed on the terminal device, for example a chatting application, a transaction application, a multimedia playback application, or the like.

According to embodiments, in order to guarantee the security of the private blockchain account, account information corresponding to the private blockchain account may be stored in the terminal device after being encrypted.

Specifically, in an embodiment, in order to make the adding of NFT information more flexible, NFT information of a blockchain account of the user may be added into a user e-wallet associated with the third-party application account according to the following steps, referred to as step a1 through step a3.

At step a1, after the user logs into the third-party application account, a target blockchain account may be added into the user e-wallet associated with the third-party application account based on a blockchain account addition instruction being received from the user.

In the above step a1, after a user attempts to log into the third-party application account and passes a server-side account verification, the user may associate information corresponding to the blockchain account of the user, which may serve as a trusted account, with the third-party application account that the user is currently logged into. For example, an existing blockchain account associated with the user may be added into a user e-wallet associated with the third-party application account.

At step a2, parameter information inputted by the user for acquiring NFT information is received.

For example, the parameter information may be at least one of a private key corresponding to the target blockchain account, and an identifier of a to-be-added target NFT in the target blockchain account. Based on the parameter information being a private key, all NFT digital assets in the entire blockchain account may be added into the user e-wallet associated with the third-party application account. Based on the parameter information being an NFT identifier, the target NFT specified by the user may be added to the user e-wallet associated with the third-party application account. An example of the above adding procedure is described in below with reference to step a3.

At step a3, based on the input parameter information being a private key corresponding to the target blockchain account, information associated with all NFTs included in the target blockchain account may be acquired from a blockchain server using a blockchain client in the terminal device using an identifier of the target blockchain account and the private key of the target blockchain account; NFT metadata corresponding to the NFT may be acquired from an NFT provider using the acquired NFT information, and may be stored to be associated with the target blockchain account in the user e-wallet.

Based on the input parameter information being an identifier of a target NFT to be added into the target blockchain account, NFT metadata corresponding to the target NFT may be acquired from the NFT provider using the identifier of the target NFT; it may be checked or determined whether the user is the owner of the target NFT using the NFT metadata, and the NFT metadata may be stored to be associated with the target blockchain account in the user e-wallet based on the user being determined to be the owner of the target NFT.

According to the above step a3, the user may flexibly specify all or some of NFT digital assets included in a particular blockchain account associated with the user as the digital asset to be added to the user e-wallet associated with the third-party application account.

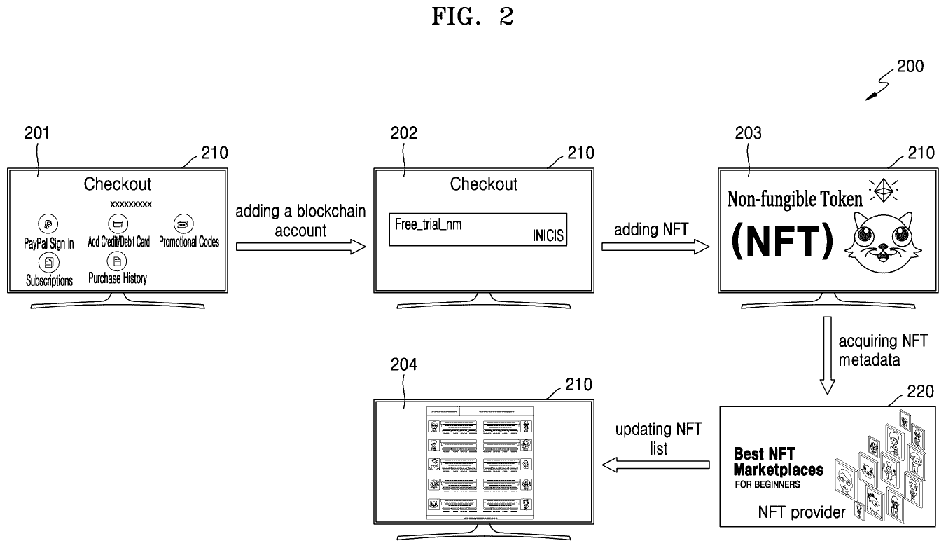

FIG. 2 is a schematic diagram illustrating an exemplary process 200 of adding a blockchain account and an NFT into a user e-wallet associated with a third-party application following the above method using a terminal device 210. Although terminal device 210 is illustrated in FIG. 2 as a television, embodiments are not limited thereto. For example, according to embodiments, the terminal device 210 may be or may include any type of electronic device, for example a computer such as a desktop computer or a laptop computer, a mobile device such as a smartphone or a tablet computer, or any other type of electronic device. As shown in FIG. 2, using screen 201 and screen 202, a user may add a blockchain account associated with the user into an account of a media-playing application in a television. Then, using screen 203, the user may input an NFT to be added. The television may acquire corresponding digital asset content from an NFT provider 220, and may add the digital asset content into a user e-wallet and displays the digital asset content to the user using screen 204.

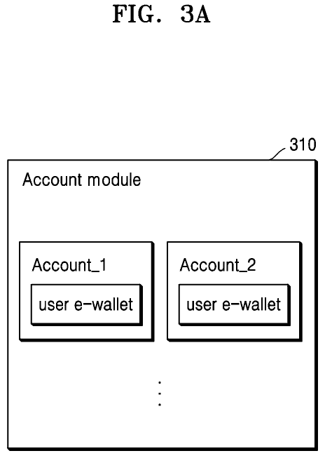

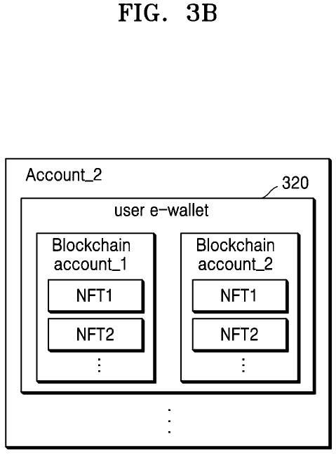

Specifically, FIGS. 3A and 3B are schematic diagrams illustrating the effects of adding NFT information into a user e-wallet associated with a third-party application account using the above method. As shown in FIG. 3A, Account_1 and Account_2 in may represent two different third-party application accounts respectively stored in an account module 310. FIG. 3B shows an example of a state of a user e-wallet after NFT information (e.g., first NFT information NFT1 and second NFT information NFT2) has been added into Account_2.

At operation 102, using a target NFT selected to be protected by the user in the user e-wallet after the user logs into the third-party application account, an off-chain transaction between a blockchain account to which the target NFT belongs and the private blockchain account may be initiated to freeze a digital asset corresponding to the target NFT.

According to operation 102, a to-be-protected NFT digital asset specified by a user may be protected by making use of the feature of digital assets that a digital asset is required to be frozen before it can be traded in an off-chain transaction.

In an embodiment, a user may select a to-be-protected target NFT using the following steps referred to as step b1 through step b2.

At step b1, after the user logs in the third-party application account, NFT metadata corresponding to an NFT selected by the user in a content display interface of the user e-wallet may be acquired from an NFT provider, and may be displayed.

According to step b1, after a user logs in a third-party application account, an NFT to be protected may be selected in an e-wallet associated with the third-party application account. According to the selection of the user, a terminal device may acquire digital asset content (e.g., NFT metadata) corresponding to the NFT from an NFT provider and may display the content to the user for the user to view and finally confirm the NFT to be protected.

At step b2, an NFT protection confirmation instruction of the user may be received, and an NFT indicated by the NFT protection confirmation instruction may be determined as the target NFT to be protected.

According to step b2, based on the user confirming the target NFT digital asset that is to be protected, an NFT protection confirmation instruction of the user may be triggered, and the terminal device may determine that the corresponding NFT is the target NFT to be protected in response to the confirmation instruction.

For example, in an embodiment, an off-chain transaction between a blockchain account to which the target NFT belongs and the private blockchain account may be initiated using the to-be-protected target NFT selected by the user in the user e-wallet using the following steps, referred to as step c1 through step c4.

At step c1, based on the user selecting the target NFT to be protected, a private key of a blockchain account to which the target NFT belongs inputted by the user may be received.

Step c1 may include acquiring a private key of a blockchain account to which a to-be-protected target NFT belongs in order to perform account verification in an off-chain transaction.

According to embodiments, account information corresponding to the private blockchain account may already be stored in a terminal device at the time of account creation, and the private blockchain account may only be used in the terminal device that requests the account creation, and may only be used for establishing an off-chain transaction in order to freeze a digital asset, thus the user may not need to record the information of the private blockchain account to use the information in other devices. Therefore, in order to protect the security of the private blockchain account and reduce user operations, the account information corresponding to the private blockchain account may be transparent to the user, and the user may not be required to input a private key of the private blockchain account when using the private blockchain account.

At step c2, a blockchain server may be triggered by a blockchain client in the terminal device to verify the validity of the blockchain account to which the target NFT belongs and the private blockchain account using the account information corresponding to the blockchain account to which the target NFT belongs and the private blockchain account. The account information may include an account identifier and a private key.

Step c2 may include triggering the blockchain server to verify the validity of the blockchain accounts of both sides of an off-chain transaction respectively.

At step c3, after the verification is passed (e.g., after the verification succeeds), an off-chain transaction channel corresponding to the off-chain transaction may be generated, and may be fed back or transmitted to an account server.

Here, after receiving information fed back by (e.g., received from) the blockchain server indicating that the verifications of the blockchain accounts of both sides of the off-chain transaction has succeeded, the terminal device may generate an off-chain transaction channel for the off-chain transaction, and may feed back or transmit the off-chain transaction channel to the account server, so that the account server may trigger the blockchain server to record the off-chain transaction channel information in the blockchain, and freeze the transacted digital asset.

At step c4, the blockchain server may be triggered by the account server to freeze a digital asset corresponding to the off-chain transaction channel based on the feedback (e.g., based on receiving the off-chain transaction channel).

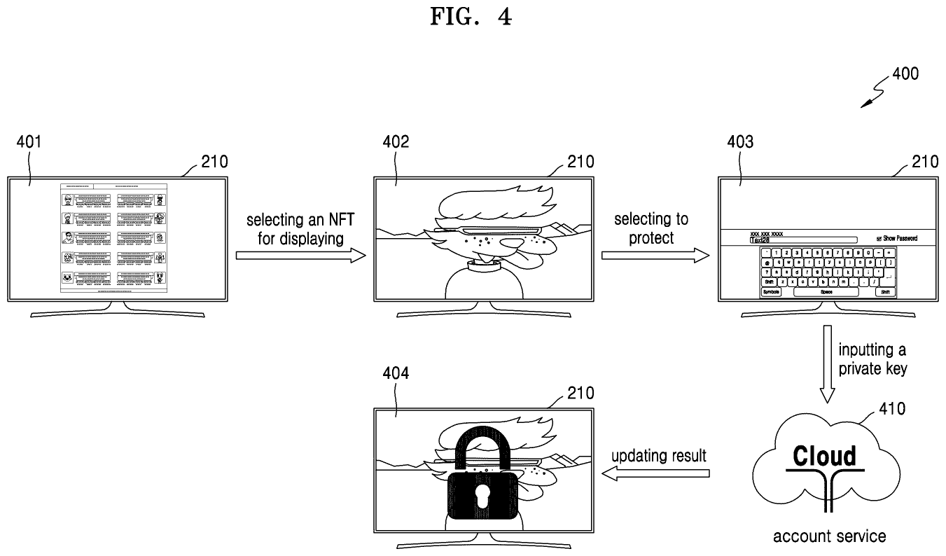

FIG. 4 is a schematic diagram illustrating an exemplary process 400 of protecting an NFT digital asset using the above method using the terminal device 210. As shown in FIG. 4, a digital asset under protection may be in a frozen state through the off-chain transaction and further transactions may not be allowed. In such case, an unauthorized user cannot transfer the protected digital asset using a blockchain account key. For example, after viewing the digital asset using screen 401 and screen 402, the unauthorized user may attempt to transfer the digital asset, for example by entering the private key using screen 403. However, a cloud server 410 (e.g., the account server, the blockchain server, or another server) may provide information to the terminal device indicating that the digital asset is frozen due to the off-chain transaction, and a screen 404 may be displayed, indicating that the unauthorized transfer of the digital asset is denied.

At operation 103, after the user logs into the third-party application account, the off-chain transaction corresponding to a frozen digital asset may be canceled to unfreeze the frozen digital asset corresponding to the off-chain transaction based on the frozen digital asset satisfying a predetermined NFT protection cancellation condition.

Operation 103 may include unfreezing a digital asset based on the digital being is no longer required to be protected by the user, and thus may implement a protection removing function.

For example, in an embodiment, the NFT protection cancellation condition may be satisfied based on at least one of a predetermined protection effective period of the frozen digital asset expiring, and an NFT protection cancellation instruction being received from the The above protection effective period may be set by the user according to the actual contents of the digital asset during the process of selecting the target NFT to be protected, which is not elaborated herein.

For example, in an embodiment, the off-chain transaction may be canceled using the following steps, referred to as step d1 through step d3.

At step d1, a private key of a blockchain account to which the first NFT belongs inputted by the user may be received based on detecting that a frozen digital asset of a first NFT satisfies the NFT protection cancellation condition after the user logs in the third-party application account.

The above first NFT may be an NFT currently selected by the user to be unprotected (e.g., selected by the user for removal of protection).

Step d1 may include acquiring a private key of a blockchain account to which a target NFT whose protection is to be cancelled belongs, in order to verify a corresponding account during cancellation of an off-chain transaction.

At step d2, a blockchain server may be triggered by a blockchain client in the terminal device to perform verification of the validity of the blockchain account to which the first NFT belongs and account information corresponding to the private blockchain account using account information corresponding to the blockchain account to which the first NFT belongs and account information corresponding to the private blockchain account. The account information may include an account identifier and a private key. For example, the account information corresponding to the blockchain account may include an account identifier corresponding to the blockchain account and the private key corresponding to the blockchain account.

At step d3, after the verification is passed (e.g., after the verification succeeds), an off-chain transaction channel corresponding to the off-chain transaction may be closed, and the blockchain server may be triggered to unfreeze a corresponding digital asset based on the closing of the off-chain transaction channel.

Step d3 may include unfreezing a digital asset traded in an off-chain transaction by closing the off-chain transaction channel, in order to cancel the protection of the corresponding digital asset.

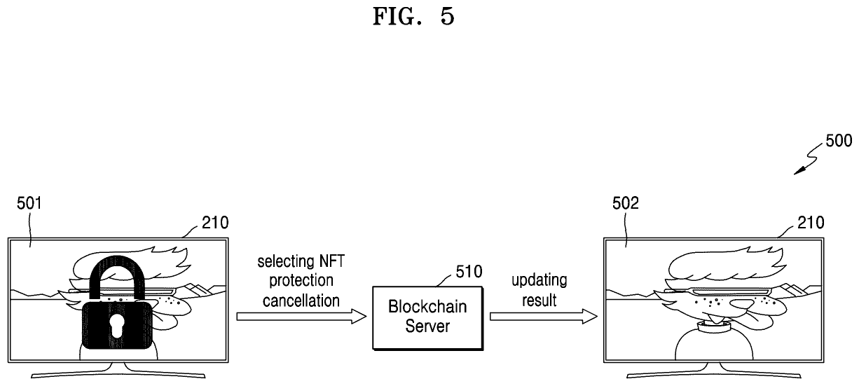

FIG. 5 is a schematic diagram illustrating an example process 500 of canceling protection of an NFT digital asset using the above method using the terminal device 210. As shown in FIG. 5, after a user may select to unprotect a target NFT using screen 501, a digital asset corresponding to the target NFT may be unfrozen through closing an off-chain transaction channel by a blockchain server 510. In such case, the user may initiate a transaction of the digital asset corresponding to the target NFT, for example using screen 502.

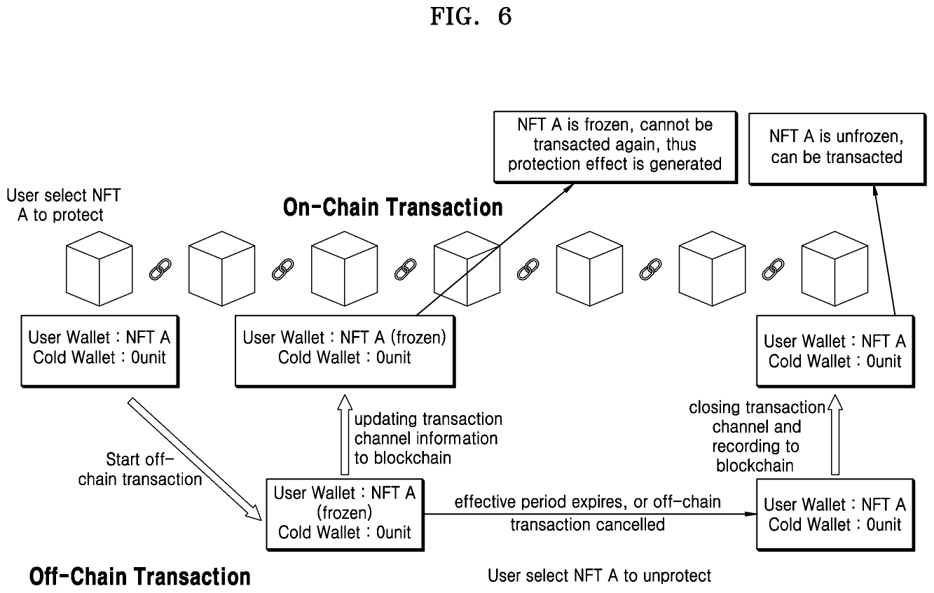

FIG. 6 is a schematic diagram illustrating an example of an off-chain transaction implemented using the method of the above embodiments. As shown in FIG. 6, according to the above method embodiments, a digital asset may be protected by creating a private blockchain account (e.g., the cold wallet illustrated in FIG. 6) and using an off-chain transaction between a blockchain account to which an NFT in a user e-wallet belongs (e.g., the user wallet illustrated in FIG. 6) and the private blockchain account. The protecting effect of putting an NFT digital asset into a safe may be achieved, and therefore a reliable technical scheme is provided for users to protect the NFT digital assets. In addition, the steps of the above technical scheme may be executed on the premise that the user has successfully logged into a third-party application account, which may take advantage of the secure login verification schemes associated with the third-party application account to enhance the security of NFT digital assets.

Embodiments of the present disclosure also provide an apparatus for protecting NFT digital assets based on the above method embodiments.

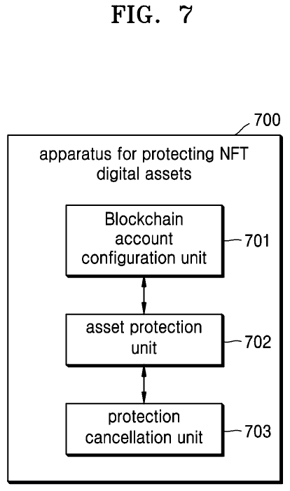

As shown in FIG. 7, the apparatus 700 may include a blockchain account configuration unit 701, configured to create a private blockchain account for a user using a third-party application account of the user, and add NFT information of a blockchain account of the user into a user e-wallet associated with the third-party application account, the blockchain account added is different from the private blockchain account;

The apparatus 700 may further include an asset protection unit 702, configured to initiate, using a target NFT selected to be protected by the user in the user e-wallet after the user logs in the third-party application account, an off-chain transaction between the blockchain account to which the target NFT belongs and the private blockchain account to freeze a digital asset corresponding to the target NFT; and

The apparatus 700 may further include an protection cancellation unit 703, configured to cancel, an off-chain transaction corresponding to a frozen digital asset when the frozen digital asset satisfies a preset NFT protection cancellation condition after the user logs into the third-party application account, to unfreeze the digital asset corresponding to the off-chain transaction.

According to embodiments, the above method and apparatus embodiments may be related. Because the principles of the method and apparatus for solving the problems are similar, the apparatus and the method may be implemented with reference to each other, thus redundant or duplicative descriptions thereof are omitted herein.

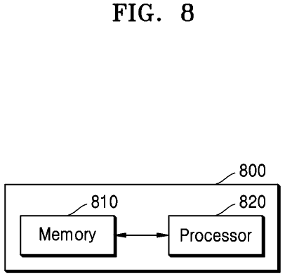

FIG. 8 is a schematic diagram illustrating the structure of electronic device for protecting non-fungible token (NFT) digital assets according to an embodiment of the present disclosure. In embodiments, the electronic device 800 illustrated in FIG. 8 may correspond to the terminal device 210 described above, be embodiments are not limited thereto.

The electronic device 800 for protecting non-fungible token (NFT) digital assets 800 may include a memory 810 and a processor 820.

The memory 810 may store an application executable by a processor 820 to perform the method for protecting non-fungible token (NFT) digital assets as described above.

The memory 810 may store an application executable by a processor 820 to create, using a third-party application account of the user, a private blockchain account for the user, and add NFT information of a blockchain account of the user into a user e-wallet associated with the third-party application account.

The memory 810 may store an application executable by a processor 820 to initiate, using a target NFT selected to be protected by the user in the user e-wallet after the user logs into the third-party application account, an off-chain transaction between the blockchain account to which the target NFT belongs and the private blockchain account to freeze a digital asset corresponding to the target NFT.

The memory 810 may store an application executable by a processor 820 to cancel, after the user logs into the third-party application account, the off-chain transaction corresponding to the frozen digital asset to unfreeze the frozen digital asset based on the frozen digital asset satisfying a predetermined NFT protection cancellation condition.

The processor 820 may control some or all operations of the electronic device 800 and may be used in the same sense as a controller.

The processor 820 may control all the operations of the electronic device 800 and a flow of signals between the internal components of the electronic device 800 and perform a function of processing data.

The processor 820 may include RAM (not shown) that stores signals or data input from outside of the electronic device 800 or is used as a storage area corresponding to various operations performed by the electronic device 800, and ROM (not shown) that stores a control program for controlling the electronic device 800.

Furthermore, the processor 820 may include a plurality of processors.

For example, the processor 820 may be implemented as a main processor and a sub processor (not shown) operating in a sleep mode.

In addition, the processor 820 may include at least one of a central processing unit (CPU), a graphic processing unit (GPU), and a video processing unit (VPU).

The processor 820 may create, using a third-party application account of the user, a private blockchain account associated with the user, and add NFT information included in a blockchain account of the user into a user e-wallet associated with the third-party application account.

The processor 820 may initiate, using a target NFT selected to be protected by the user in the user e-wallet after the user logs into the third-party application account, an off-chain transaction between the blockchain account to which the target NFT belongs and the private blockchain account to freeze a digital asset corresponding to the target NFT.

The processor 820 may cancel, after the user logs into the third-party application account, the off-chain transaction corresponding to the frozen digital asset to unfreeze the frozen digital asset when the frozen digital asset satisfies a preset NFT protection cancellation condition.

Based on the above method embodiments, embodiments of the present disclosure may also provide a corresponding electronic device. The electronic device may include a processor and a memory. The memory may store an application executable by the processor to perform the method for protecting NFT digital assets as described above. For example, a system or apparatus including a storage medium may be provided. The storage medium may store software program codes that implement the functions of any one of the above embodiments and cause a computer (or a CPU or a micro processor unit (MPU)) of the system or apparatus to read out and execute the program codes stored in the storage medium. Furthermore, some or all of actual operations may be performed by an operating system or the like operating on the computer in response to instructions of the program codes. The program codes read out from the storage medium may also be written into a memory provided in an extension board inserted into the computer or written into a memory provided in an extension unit connectable to the computer, and a CPU or the like installed on the extension board or the extension unit is made to perform some or all of the actual operations in response to instructions of the program codes to realize the functions of any one of the above embodiments.

The memory may be implemented as various storage media such as electrically erasable programmable read-only memory (EEPROM), flash memory, programmable program read-only memory (PROM), etc. The processor may be implemented to include one or multiple central processing units or one or multiple field programmable gate arrays. The field programmable gate arrays are integrated with one or multiple central processing unit cores. Specifically, the central processing unit or central processing unit core may be implemented by a CPU or an MCU.

Embodiments of the present disclosure may implement a computer program product, including computer programs/instructions that are executable by a processor to implement the steps of the method for protecting NFT digital assets as described in the above first method embodiment.

It is to be noted that one or more of the steps and operations described above may be omitted without departing from the scope of the disclosure, and the order of the various steps and operations is not fixed and may be adjusted, according to embodiments.

Hardware modules in the various embodiments may be implemented mechanically or electronically. For example, a hardware module may include a specially designed permanent circuit or logic device (e.g. a dedicated processor such as an FPGA or an ASIC) to perform particular operations. The hardware modules may also include a programmable logic device or circuit (e.g. including a general purpose processor or other programmable processors) temporarily configured by software to perform particular operations. Whether to implement the hardware modules mechanically or using a dedicated permanent circuit or using a temporarily configured circuit (e.g. configured by software) may depend on cost and time considerations.

As used herein, “schematic” may mean “serving as an instance, example, or illustration”. Any illustration and embodiment described herein as “schematic” should not be construed as a more preferred or advantageous technical solution. For simplicity of the drawings, only those portions related to the present disclosure are schematically depicted in the figures and are not necessarily representative of an actual structure of a product. In addition, for simplicity and ease of understanding, only one of components having the same structure or function is schematically drawn or marked in some figures. As used herein, “one” does not intend to limit the number of elements related to the present disclosure to “only one”, and “one” does not intend to exclude the cases where the number of elements related to the present disclosure is “more than one”. As used herein, “upper”, “lower”, “front”, “back”, “left”, “right”, “inner”, “outer”, or the like are used merely to indicate relative position relationships between related elements, and do not limit the absolute positions of these related elements.

The above description of embodiments of the present disclosure is not intended to limit the protection scope of the present disclosure. Any modifications, equivalent replacements, improvements, etc. that come within the spirit and principles of the present disclosure are intended to be within the protection scope of the present disclosure.

A method for protecting NFT digital assets is implemented by a terminal device of a user.

The method may include creating, using a third-party application account of the user, a private blockchain account for the user, and adding NFT information included in a blockchain account of the user into a user e-wallet associated with the third-party application account, the blockchain account added being different from the private blockchain account.

The method may further include initiating, using a target NFT selected to be protected by the user in the user e-wallet after the user logs into the third-party application account, an off-chain transaction between a blockchain account to which the target NFT belongs and the private blockchain account, to freeze a digital asset corresponding to the target NFT.

The method may further include canceling, after the user logs in the third-party application account, an off-chain transaction corresponding to a frozen digital asset to unfreeze the frozen digital asset based on the frozen digital asset satisfying a predetermined NFT protection cancellation condition.

The creating, using the third-party application account of the user, the private blockchain account for the user may include based on an NFT security service instruction of the user being received after the user logs in the third-party application account, triggering, by a blockchain client in the terminal device, a blockchain server to create the private blockchain account for the user using device information corresponding to the terminal device and account information corresponding to the third-party application account, and storing metadata corresponding to the private blockchain account fed back by or received from the blockchain server into the terminal device.

The adding the NFT information of the blockchain account of the user into the user e-wallet associated with the third-party application account may include: adding the blockchain account into the user e-wallet associated with the third-party application account based on a blockchain account addition instruction being received from the user after the user logs into the third-party application account, receiving parameter information inputted by the user for acquiring the NFT information, based on the input parameter information being a private key of the blockchain account, acquiring, by a blockchain client in the terminal device, other NFT information included in the blockchain account from a blockchain server using an identifier of the blockchain account and the private key, acquiring other NFT metadata corresponding to the other NFT information from an NFT provider using the acquired NFT information, and storing the other NFT metadata corresponding to the blockchain account into the user e-wallet, and based on the input parameter information being an identifier of the target NFT in the blockchain account, acquiring NFT metadata corresponding to the target NFT from the NFT provider using the identifier of the target NFT, checking whether an owner of the target NFT is the user using the NFT metadata, and storing the NFT metadata corresponding to the blockchain account into the user e-wallet based on the owner of the target NFT being the user.

The target NFT to be protected may be selected by acquiring NFT metadata corresponding to the NFT selected by the user from an NFT provider, and displaying the NFT metadata in a content display interface corresponding to the user e-wallet after the user logs in the third-party application account, and determining, based on an NFT protection confirmation instruction being received from the user, the NFT identified by the NFT protection confirmation instruction to be the target NFT to be protected.

The initiating the off-chain transaction between the blockchain account to which the target NFT belongs and the private blockchain account using the target NFT selected to be protected by the user in the user e-wallet may include: receiving a private key inputted by the user when the target NFT to be protected is selected by the user, wherein the private key is a private key of the blockchain account to which the target NFT belongs, triggering, by a blockchain client in the terminal device, a blockchain server to perform verification of validity of the blockchain account to which the target NFT belongs and the private blockchain account using account information corresponding to the blockchain account to which the target NFT belongs and account information corresponding to the private blockchain account, wherein the account information includes an account identifier and the private key, generating an off-chain transaction channel corresponding to the off-chain transaction, and feeding back or transmitting the off-chain transaction channel to an account server after the verification is passed and triggering, by the account server based on the off-chain transaction channel, the blockchain server to freeze the digital asset corresponding to the off-chain transaction using the off-chain transaction channel.

The canceling the off-chain transaction corresponding to the frozen digital asset may include: receiving a private key inputted by the user after the user logs into the third-party application account, based on a detection that the frozen digital asset of the target NFT satisfies the NFT protection cancellation condition, wherein the private key is a private key of the blockchain account to which the target NFT belongs, triggering, by a blockchain client in the terminal device, a blockchain server to perform verification of valid of the blockchain account to which the target NFT belongs and account information corresponding to the private blockchain account using account information corresponding to the blockchain account to which the target NFT belongs and account information corresponding to the private blockchain account, wherein the account information includes an account identifier and a private key, closing an off-chain transaction channel corresponding to the frozen digital asset after the verification is passed or succeeds, and triggering the blockchain server to unfreeze the digital asset corresponding to the off-chain transaction channel based on the closing of the off-chain transaction channel.

The NFT protection cancellation condition may be satisfied based on at least one of a preset protection effective period of the frozen digital asset expiring, and an NFT protection cancellation instruction of the user being received.

The method may further include updating the off-chain transaction channel corresponding to the off-chain transaction to the blockchain account to which the target NFT belongs.

Embodiments of the present disclosure may also provide an apparatus for protecting NFT digital assets.

The apparatus may include a blockchain account configuration unit, which may be configured to create, using a third-party application account of a user, a private blockchain account for the user, and add NFT information of included in blockchain account associated with the user into a user e-wallet associated with the third-party application account, the blockchain account added being different from the private blockchain account;

The apparatus may further include an asset protection unit, which may be configured to initiate, using a target NFT selected to be protected by the user in the user e-wallet after the user logs in the third-party application account, an off-chain transaction between a blockchain account to which the target NFT belongs and the private blockchain account to freeze a digital asset corresponding to the target NFT; and

The apparatus may further include an protection cancellation unit, which may be configured to cancel, after the user logs into the third-party application account, an off-chain transaction corresponding to a frozen digital asset to unfreeze the frozen digital asset when the frozen digital asset satisfies a preset NFT protection cancellation condition.

Embodiments of the present disclosure also provide an electronic device which includes a processor and a memory.

The memory may store an application executable by the processor to perform the method for protecting NFT digital assets as described above.

Embodiments of the present disclosure may also provide a computer-readable storage medium storing computer-readable instructions for performing the method for protecting NFT digital assets as described above.

Embodiments of the present disclosure may also provide a computer program product which includes computer programs/instructions executable by a processor to implement the steps of the method for protecting NFT digital assets as described above.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

In view of the above, according to the scheme for protecting NFT digital assets according to the embodiments of the present disclosure, after a user logs into a third-party application account, the user may add an existing blockchain account of the user into a user e-wallet associated with a third-party application account, and a private blockchain account may be created for the user. Then, a digital asset to be protected by the user may be frozen using an off-chain transaction between the private blockchain account and a blockchain account that has been added into the above user e-wallet. In this way, during the period when the digital asset is frozen, the digital asset may be prevented from being transferred illegally through a transaction even if a private key of the blockchain account is stolen, thereby improved protection of the digital asset may be achieved. Accordingly, when protection of the digital asset is to be cancelled, the digital asset may be unfrozen by canceling the corresponding off-chain transaction. Thus, a function similar to that of a safe may be achieved using a third-party application account on a terminal device. Accordingly, an effective solution of protecting NFT digital assets may be provided to users by making use of the frozen of a digital asset during an off-chain transaction between blockchain accounts.

What is claimed is:

1. A method for protecting non-fungible token (NFT) digital assets, implemented by a terminal device of a user, the method comprising:
creating, using a third-party application account associated with the user, a private blockchain account for the user;
adding NFT information included in a blockchain account associated with the user into an e-wallet corresponding to the third-party application account, wherein the blockchain account is different from the private blockchain account;
based on a target NFT being selected by the user in the e-wallet after the user logs into the third-party application account, initiating an off-chain transaction between the blockchain account and the private blockchain account in order to freeze a digital asset corresponding to the target NFT; and
canceling the off-chain transaction corresponding to the frozen digital asset in order to unfreeze the frozen digital asset based on the frozen digital asset satisfying a predetermined NFT protection cancellation condition.

2. The method according to claim 1, wherein the creating the private blockchain account comprises:
based on an NFT security service instruction being received from the user after the user logs in the third-party application account:
triggering, by a blockchain client included in the terminal device, a blockchain server to create the private blockchain account for the user based on device information corresponding to the terminal device and account information corresponding to the third-party application account,
receiving metadata corresponding to the private blockchain account from the blockchain server, and
storing the metadata in the terminal device.

3. The method according to claim 1, wherein the adding the NFT information into the e-wallet comprises:
adding the blockchain account into the e-wallet based on a blockchain account addition instruction received from the user after the user logs into the third-party application account;
receiving parameter information received from the user for acquiring the NFT information;
based on the received parameter information comprising a private key associated with the blockchain account, acquiring, by a blockchain client included in the terminal device, other NFT information included in the blockchain account from a blockchain server using an identifier of the blockchain account and the private key, acquiring other NFT metadata corresponding to the NFT information from an NFT provider using the acquired other NFT information, and storing the other NFT metadata into the e-wallet; and
based on the received parameter information comprising an identifier of the target NFT in the blockchain account, acquiring the NFT metadata corresponding to the target NFT from the NFT provider using the identifier of the target NFT, determining whether the user is an owner of the target NFT based on the NFT metadata, and storing the NFT metadata into the e-wallet based on the user being the owner of the target NFT.

4. The method according to claim 1, wherein the selecting the target NFT comprises:
after the user logs in the third-party application account, acquiring NFT metadata corresponding to an NFT and displaying the NFT metadata in a content display interface of the e-wallet; and
based on receiving an NFT protection confirmation instruction from the user, selecting the NFT as the target NFT.

5. The method according to claim 1, wherein the initiating the off-chain transaction comprises:
receiving a private key from the user based on the target NFT being selected by the user, wherein the private key is associated with the blockchain account;
triggering, by a blockchain client included in the terminal device, a blockchain server to perform a verification of the blockchain account and the private blockchain account using account information corresponding to the blockchain account and account information corresponding to the private blockchain account, wherein the account information corresponding to the blockchain account comprises an account identifier and the private key;
generating an off-chain transaction channel corresponding to the off-chain transaction, and transmitting the off-chain transaction channel to an account server after the verification succeeds; and
wherein, based on the off-chain transaction channel, the account server triggers the blockchain server to freeze the digital asset corresponding to the off-chain transaction using the off-chain transaction channel.

6. The method according to claim 1, wherein the canceling the off-chain transaction comprises:
based on determining that the frozen digital asset of the target NFT satisfies the predetermined NFT protection cancellation condition, receiving a private key associated with the blockchain account from the user after the user logs into the third-party application account;
triggering, by a blockchain client in the terminal device, a blockchain server to perform a verification of the blockchain account and the private blockchain account based on account information corresponding to the blockchain account and account information corresponding to the private blockchain account, wherein the account information corresponding to the blockchain account comprises an account identifier and the private key; and
closing an off-chain transaction channel corresponding to the frozen digital asset after the verification succeeds, and triggering the blockchain server to unfreeze the digital asset corresponding to the off-chain transaction channel based on the closing of the off-chain transaction channel.

7. The method according to claim 1, wherein the predetermined NFT protection cancellation condition is satisfied based on at least one of: a predetermined protection effective period of the frozen digital asset expiring, and
an NFT protection cancellation instruction of the user being received.

8. The method according to claim 1, further comprising:
updating an off-chain transaction channel corresponding to the off-chain transaction based on the blockchain account.

9. An apparatus for protecting non-fungible token (NFT) digital assets, comprising:
at least one processor; and
a memory storing instruction which, when executed by the at least one processor, cause the apparatus to:
create a private blockchain account for a user using a third-party application account associated with the user, and add NFT information included in a blockchain account associated with the user into an e-wallet corresponding to the third-party application account, wherein the blockchain account is different from the private blockchain account;
based on a target NFT being selected by the user in the e-wallet after the user logs into the third-party application account, initiate an off-chain transaction between the blockchain account and the private blockchain account in order to freeze a digital asset corresponding to the target NFT; and
cancel the off-chain transaction based on the frozen digital asset satisfying a predetermined NFT protection cancellation condition after the user logs into the third-party application account, in order to unfreeze the frozen digital asset.

10. A non-transitory computer-readable storage medium, storing computer-readable instructions which, when executed by at least one processor of a device for protecting non-fungible token (NFT) digital assets, cause the device to:
create, using a third-party application account associated with a user, a private blockchain account for the user;
add NFT information included in a blockchain account associated with the user into an e-wallet corresponding to the third-party application account, wherein the blockchain account is different from the private blockchain account;
based on a target NFT being selected by the user in the e-wallet after the user logs into the third-party application account, initiate an off-chain transaction between the blockchain account and the private blockchain account in order to freeze a digital asset corresponding to the target NFT; and
cancel the off-chain transaction corresponding to the frozen digital asset in order to unfreeze the frozen digital asset based on the frozen digital asset satisfying a predetermined NFT protection cancellation condition.
